(19) United States
(12) Patent Application Publication
(10) Pub. No.: US 2022/0041948 A1
(43) Pub. Date: Feb. 10, 2022

(54) METHOD FOR PRODUCING CHARCOAL

(71) Applicant: Alpenkohle GmbH, Fliess (AT)

(72) Inventor: Benjamin HUPFAUF, Fliess (AT)

(21) Appl. No.: 17/603,411

(22) PCT Filed: Apr. 16, 2020
(86) PCT No.: PCT/EP2020/060715

§ 371 Date: Oct. 13, 2021

(30) Foreign Application Priority Data
Apr. 16, 2019 (EP) 19169648.3

(51) Int. Cl. C10L 5/44; C10B 53/02; C10B 57/00; C10B 27/06; C10B 39/04; C10L 5/36; C10L 5/14; C10J 3/48; C10J 3/50; C10J 3/66

(52) U.S. Cl. CPC C10L 5/447; C10L 2290/547; C10B 57/005; C10B 27/06; C10B 39/04; C10L 5/361; C10L 5/14; C10J 3/482; C10J 3/503; C10J 3/66; C10L 2200/0469; C10L 2270/08; C10L 2290/46; C10L 2290/24; C10L 2290/08; C10L 2290/04; C10L 2290/145; C10L 2230/02; C10L 2290/02; C10L 2290/32; C10B 53/02

(57) ABSTRACT

A process for the production of charcoal comprising the steps of: a) feeding biomass, in particular wood chips, into a pyrolysis unit, in which the wood chips are pyrolyzed into a full stream comprising solid, liquid and gaseous material, b) feeding the full stream and a gasifying agent into an oxidation unit, wherein the full stream is oxidized at least partially and transported pneumatically, c) feeding the partially oxidized full stream from the oxidation unit into a reduction unit arranged essentially vertically, the material outlet of the oxidation unit being connected to the reduction unit, with the cross-section of the reduction unit increasing as the distance from the material outlet of the oxidation unit increases, the flow rate of the full stream in the reduction unit being adapted to the material of the full stream and to the shape of the flow cross-section of the reduction unit in such a way that a stable fixed bed kept in suspension is formed in the reduction unit, d) removing the raw charcoal from the reduction unit via an overflow, e) separating gaseous components in a hot gas filter and collecting the charcoal, and f) quenching the collected charcoal with water.

The invention relates to a process for the production of charcoal, as well as to charcoal obtainable by this process.

### BACKGROUND OF THE INVENTION

Charcoal is produced by heating wood through pyrolytic decomposition and essentially in the absence of air. In known processes according to the prior art, the wood is first heated and dried and subsequently subjected to pyrolytic decomposition at higher temperatures so that gaseous and liquid components of the wood are gasified and charcoal remains as a residue at the end of the pyrolysis process.

The carbon content in the finished charcoal varies depending on the quality of the biomass used. For charcoal of a particularly high quality and with a high carbon content, slowly growing tropical woods currently have to be used in some cases. A high carbon content can only be achieved by charring pure wood, whereby a carbon content of up to 80% by weight is achievable in the finished charcoal with energy-intensive charring methods. If bark or periderm is also present during the charring, the carbon content in the finished charcoal drops significantly.

Furthermore, charcoal produced according to known processes has pieces of different sizes with a diameter ranging from fractions of a millimetre to several centimetres. Such a size distribution is unsuitable for numerous areas of application. Quite a few areas of application require small particles with a homogeneous size distribution.

Methods with multi-stage gasification processes for generating thermal energy from biomass are disclosed, for example, in EP 2 479 244 A2 and US 2010/095592 A1. In those documents, biomass is converted into combustible gas in a three-stage gasification process which comprises a pyrolysis unit, an oxidation unit and a reduction unit. In doing so, coke or, respectively, ash can be removed from the process as a by-product. However, the coke removed in this way has significant disadvantages in terms of absence of pollutants, particle size and also carbon content.

### BRIEF DESCRIPTION OF THE INVENTION

It is therefore the object of the present invention to provide a process for the production of charcoal with a very high carbon content and a very low pollutant content, in which low-quality biomass can be used. In addition, the finished charcoal should have a homogeneous size distribution in the sub mm range.

This object is achieved by a process for the production of charcoal comprising the steps of:

a) feeding biomass, in particular wood chips, into a pyrolysis unit, in which the wood chips are pyrolyzed into a full stream comprising solid, liquid and gaseous material,
b) feeding the full stream and a gasifying agent into an oxidation unit, wherein the full stream is oxidized at least partially and transported pneumatically,
c) feeding the partially oxidized full stream from the oxidation unit into a reduction unit arranged essentially vertically, the material outlet of the oxidation unit being connected to the reduction unit, with the cross-section of the reduction unit increasing as the distance from the material outlet of the oxidation unit increases, the flow rate of the full stream in the reduction unit being adapted to the material of the full stream and to the shape of the flow cross-section of the reduction unit in such a way that a stable fixed bed kept in suspension is formed in the reduction unit,
d) removing the raw charcoal from the reduction unit via an overflow, and
e) separating gaseous components in a hot gas filter and collecting the charcoal,
f) quenching the collected charcoal with water, the charcoal having
a dry matter content of carbon ranging from 68 to 95%, preferably from 75 to 93% and particularly preferably from 80 to 92%,
a dry matter content of ash ranging from 4 to 18%, preferably from 5 to 13% and particularly preferably from 6 to 10%,
a mass percentage of water ranging from 5 to 50%, preferably from 10 to 40% and particularly preferably from 15 to 35%,
and preferably an inner surface area of 200 to 400 m²/g.

In doing so, in step c), a stable fluidized fixed bed is formed from the coke of the partially oxidized full stream. This means that the coke bed “floats” in the reduction unit on the pyrolysis gas stream, since the weight forces of the fixed bed are almost in equilibrium with the forces of the rising pyrolysis gas stream. As a result, there are only minor pressure losses in the coke bed and an efficient conversion of pollutants, also due to the long retention time of the pyrolysis gas.

Using such a process, charcoal can be produced with the mean particle size d₅₀ ranging from 30 to 300 μm, preferably from 40 to 250 μm and particularly preferably from 50 to 100 μm.

It has surprisingly been found that, by means of this process, wood chips, which constitute the lowest-quality waste in the timber production industry, can be processed into high-quality charcoal with a homogeneous particle size.

In a preferred embodiment variant, the gaseous components are separated in the hot gas filter with the aid of porous ceramics at a temperature of 250 to 600° C. By using the hot gas filter, the pollutants formed during the thermochemical process, such as, for example, polycyclic aromatic hydrocarbons (PAH), are prevented from condensing on the charcoal. Due to the absence of pollutants, the pure charcoal produced in this way thus complies with various certificates and regulations.

In a further embodiment variant, the charcoal can have a mass percentage of water ranging from 20 to 50%, preferably from 25 to 40% and particularly preferably from 28 to 35%.

Furthermore, the charcoal can have an inner surface area of 200 to 400 m²/g.

The charcoal produced in this way can be processed further in various processes.

In one aspect of the invention, a process for the production of barbecue charcoal briquettes is therefore provided, which is characterized in that charcoal is provided according to a process according to claim 1, comprising the following steps of
charging the charcoal into the briquetting line, with a homogenization of the charcoal occurring in the charging system,
mixing the homogenized charcoal with binders and preferably additives in the mixing apparatus,
pre-compressing the charcoal/binder/additive mixture by means of rollers for 1 to 30 minutes, preferably for 2 to 20 minutes and particularly preferably for 3 to 10 minutes, in the pre-compressor,
briquetting the pre-compressed charcoal/binder/additive mixture in the hydraulic roller briquetting plant, the mixture being guided over at least two rollers with shaping cavities at a contact pressure of 1 to 12 bar, preferably of 1.5 to 9 bar and particularly preferably of 2 to 7 bar,
drying the charcoal briquettes at a drying temperature of 50 to 140° C., preferably of 65 to 110° C. and particularly preferably of 75 to 105° C., in a convection dryer,
packaging the dry charcoal briquettes in a filling plant.

In this case, the time required for pre-compression can be compensated for by more power, i.e., by increasing the speed of the rollers. In addition, the drying temperature can be minimized with a higher fan power.

The binders can be from the group of preferably recycled vegetable oils or, respectively, fats, starches such as, e.g., rye or corn, sugar solutions such as beet or sugar cane molasses and cellulose compounds and can have a mass percentage of 0.5 to 20%, preferably of 1 to 15% and particularly preferably of 2 to 10%, based on the dry matter of the charcoal briquettes.

The additives can be selected from the group of calcium compounds, aluminas, gum arabic and clay minerals and can have a mass percentage of 0 to 10%, preferably of 0.5 to 8% and particularly preferably of 1 to 5%, based on the dry matter of the charcoal briquettes.

In principle, additives are optionally added in order to improve specific properties of the barbecue charcoal, such as, for example, ignition behaviour and strength.

In one aspect, the invention relates to a process for the production of activated charcoal, characterized in that charcoal is provided according to a process according to claim 1, comprising the following steps of
charging the charcoal into the activation unit, with a homogenization of the charcoal being performed in the charging system,
activating the homogenized charcoal in the activation unit with an activating agent, preferably water vapour or carbon dioxide, at a temperature of 600 to 1100° C., preferably of 700 to 1000° C. and particularly preferably of 800 to 950° C., for 5 to 180 minutes, preferably for 10 to 120 minutes and particularly preferably for 15 to 90 minutes, wherein the conversion of the activating agent per 1 g of charcoal is chosen to be 0.1 to 2 g, preferably 0.3 to 1.8 g and particularly preferably 0.4 to 1.6 g,
finishing the activated charcoal,
packaging the finished activated charcoal in the filling plant.

The charcoal according to the invention offers the advantage over fossil coal, which usually is used for activation, that it has an inner surface area of approx. 200-400 m²/g even before activation. In contrast, fossil coal has no significant inner surface area.

After activation, the charcoal preferably has an inner surface area of approx. 1000 m²/g.

The second essential parameter of activated coal is the pore size, with a distinction being made between micro-, meso- and macropores. The activated charcoal according to the invention can be adjusted specifically to its application in its pore structure. For example, activated charcoals can be produced with a preferably micro- or preferably meso- or preferably macrostructure.

During finishing, the activated charcoal is preferably brought into other forms such as granules or pellets, wherein it can also be used, for example, as powdered activated charcoal.

In a further aspect, the invention relates to a process for the production of industrial charcoal, in particular an aggregate for concrete or a secondary raw material for the metal-working industry, characterized in that charcoal is provided according to a process according to claim 1, comprising the following steps of
charging the charcoal into the processing unit,
dividing the charcoal in the classifying unit, wherein, depending on the particle size, it is divided into a coarse, a middle and a fine fraction, the coarse fraction having a particle size of 0.4 to 10 mm, preferably of 0.3 to 6 mm and particularly preferably of 0.25 to 4 mm, the middle fraction having a particle size of 100 to 400 μm, preferably of 75 to 300 μm and particularly preferably of 50 to 250 μm, the fine fraction having a particle size of 0 to 100 μm, preferably of 0 to 75 μm and particularly preferably of 0 to 50 μm,
processing the divided charcoal depending on the fraction to form a compact or a finer material in the compacting or, respectively, grinding unit, wherein, after the grinding process, the finer charcoal is again fed into the classifying unit and divided,
finishing the compacted industrial charcoal,
packaging the finished industrial charcoal in the filling plant.

During finishing, compacts and agglomerates such as, for example, briquettes, pellets and granules can be produced from the charcoal.

During finishing, the charcoal can be impregnated with preferably mineral substances such as, for example, potassium, sodium and calcium salts.

In the filling plant, packages can be selected from the group of kraft papers, cardboards, cloth bags and plastic packages.

One aspect of the invention relates to a process for the production of an insulating material, wherein charcoal is produced according to a previously mentioned process and is mixed with a raw material for insulating materials. Subsequently, this mixture is processed into the insulating material. Typical raw materials for insulating materials are plastics such as polystyrene, polyurethane, formica, or other materials known from the insulation industry such as wood wool, for example. Those materials are processed as known (e.g., foamed), with the charcoal being added before the final processing.

Such a procedure leads to lighter insulating materials and possibly also to improved mechanical stability and may involve enhanced fire protection properties.

### DETAILED DESCRIPTION OF THE INVENTION

Further advantages and details of the invention are explained below by way of the figures and the descriptions of the figures.

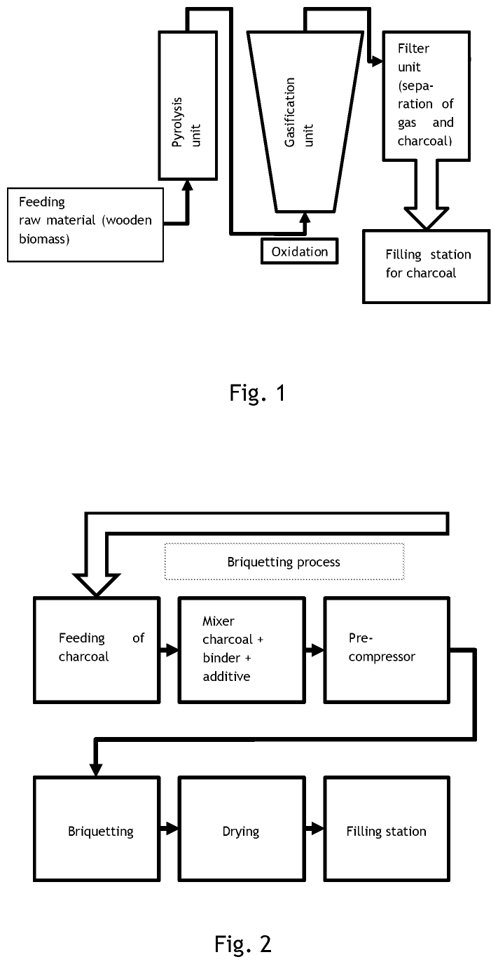

FIG. 1 schematically shows the individual steps of the manufacturing process for charcoal.

FIG. 2 schematically shows the processing into barbecue charcoal briquettes.

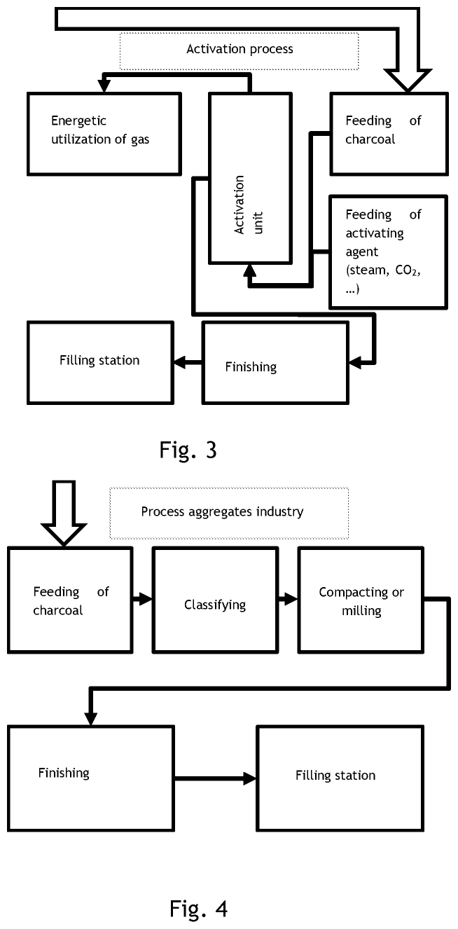

FIG. 3 schematically shows the production of activated carbon.

FIG. 4 schematically shows the production of industrial charcoal as an aggregate.

The fluidized bed technology describes a new method in the thermochemical gasification of biomass. The fluidized bed reactor describes a unique reactor design and the operation thereof. The process is depicted in FIG. 1.

Comparable gasification concepts display clear disadvantages in terms of the possibility of scaling them. Furthermore, fluidized bed gasification, for example, is associated with problems with regard to the tar concentrations in the product gas, and fixed bed systems are associated with problems due to the compression of the fuel and the exchange between solid and gaseous phases.

The concept of the floating fixed bed reactor consists in constructing a structured bed of fuel that floats on the inlet gas stream of the pyrolysis and oxidation. Without uncontrolled particle movement in the reduction zone and only a relative movement of the fuel particles within the fluidized bed, comparatively long gas residence times can be achieved, which leads to low tar concentrations in the product gas. Such low tar concentrations and the unique operating control of a fluidized bed reactor lead to a very high-quality and “pure” charcoal which is discharged from the process as a by-product. Meanwhile, the technology has demonstrated that it avoids the problems of comparable gasification technologies via more than 100,000 operating hours in commercial plants.

As illustrated in FIG. 1, biomass, in particular wood chips, is first conducted, during the gasification process, into a pyrolysis unit, in which the full stream of solid, liquid and gaseous material arises. Thereupon, the full stream is partially oxidized and transported pneumatically in the oxidation unit with the aid of a gasifying agent. The partially oxidized full stream then enters the reduction or, respectively, gasification unit, the cross-section of which is essentially conical, where the fluidized bed is formed. Through an overflow, the raw charcoal gets from the reduction unit into the filter unit, where the separation of gas and charcoal is accomplished via a hot gas filter. For the recovery of energy, the gas is then sent to a gas burner or gas motor, while the charcoal according to the invention can be further processed immediately after having been quenched with water or can be guided to a filling station.

Furthermore, the present invention relates to a processing and a refinement of the unique charcoal, which arises in the fluidized bed gasification process.

Special features of the charcoal resulting from the above-described process are as follows:
The charcoal is produced by regionally provided wood chips using the fluidized bed gasification technology. The wood chips are obtained from the low-quality woods accruing during the clearing, thinning and harvesting of forests. The product line of wood chips is understood to consist in wood intended for the production of forest wood chips. It can be comprised of debranched and non-debranched trunk parts, tree tops, branches and damaged full trees. Despite this starting wood of not very high quality, the technology that is used enables the production of a particularly high-quality and pollutant-free charcoal. The hot gas filter used, among other things, plays an important role in this, as it prevents the condensation of defective PAHs on the charcoal, which arise during the thermochemical gasification of the biomass. In contrast to cold filtration, it is prevented with a filtration at over 250° C. that the gasification process results in coal contaminated with tar, which is just waste according to the legal limit values. Moreover, only pure, pollutant-free charcoal can be further processed into barbecue charcoal so as to meet the highest quality standards.
The charcoal has a carbon content of 68 to 95% by weight, preferably of 75 to 93% by weight and particularly preferably of 80 to 92% by weight, based on the dry matter.
The charcoal has an ash content of 4 to 18% by weight, preferably of 5 to 13% by weight and particularly preferably of 6 to 10% by weight, based on the dry matter.
The charcoal is processed in the moist state and has a water content of 5 to 50% by weight, preferably of 10 to 40% by weight and particularly preferably of 15 to 35% by weight, based on the total mass. The water is added in the process to quench the charcoal after the hot gas filtration. In a further embodiment variant, the water content can also be 20 to 50% by weight, preferably 25 to 40% by weight and particularly preferably 28 to 35% by weight, based on the total mass.
The charcoal is to be regarded as a powdery charcoal with a mean particle size d₅₀ of between 30 to 300 μm, preferably between 40 to 250 μm and particularly preferably between 50 to 200 μm.

Such charcoal with the composition as indicated above and a carbon content of up to 95% by weight of the dry matter can otherwise be produced only in a pure pyrolysis process. This is mainly due to the fact that, in a subsequent gasification process, the charcoal must continue to lose energy, which is converted into gas. However, the efficiency of the fluidized bed gasification process enables the production of the charcoal of very high quality.

A processing according to the invention of said charcoal is a process for the production of high-quality barbecue charcoal briquettes. The processing takes place according to the process illustrated in FIG. 2:

As shown in FIG. 2, the charcoal having the above-mentioned properties is first charged into the briquetting line. For this purpose, the charcoal is emptied from the transport packaging into the container of the charging system. In the charging system, a homogenization of the charcoal is performed using conveying devices such as, for example, hydraulic cylinders, screw conveyors and conveyor belts.
Again via conveying devices, the homogenized charcoal gets into the mixing apparatus, where the charcoal is mixed with binders and optionally also with additives. To produce briquettes from charcoal, the addition of a binder is necessary, since the charcoal contains little or no malleable, plastic material. In this case, the binder content is 0.5 to 20%, preferably 1 to 15% and particularly preferably 2 to 10% of the dry matter. Different starches (e.g., wheat, rye, corn), sugar solutions (e.g., sugar cane molasses, beet molasses), cellulose compounds or, particularly preferably, binders made of vegetable oils or fats, which can be recycled, are used as binders. The use of vegetable oils or, respectively, fats as binders is not found in the state of the art and would enable an ecological use of recycled oils and fats.
The proportion of additives is 0 to 10%, preferably 0.5 to 8% and particularly preferably 1 to 5% of the dry matter. Substances such as, for example, clay or aluminas, calcium compounds, gum arabic or other clay minerals are used as additives. Said additives are optionally added in order to improve specific properties of the barbecue charcoal such as, for example, ignition behaviour and strength. Furthermore, different odorous natural substances and non-carbonized materials may also be admixed as additives. Of course, food grade quality is a prerequisite for the additives used.
Again via conveying devices, the charcoal/binder/additive mixture gets, as schematically illustrated in FIG. 2, into the pre-compressor, where the required mechanical stability of the charcoal briquettes is achieved. In doing so, the charcoal/binder/additive mixture is pre-compressed by rollers in a container. The compression time is 1 to 30 minutes, preferably 2 to 20 minutes and particularly preferably 3 to 10 minutes, and can be reduced with the aid of power, i.e., with a higher speed of the rollers.
Again via conveying devices, the pre-compressed charcoal/binder/additive mixture gets into a hydraulic roller briquetting plant, where the pre-compressed charcoal/binder/additive mixture is guided over at least two rollers with shaping cavities. In doing so, a contact pressure of 1 to 12 bar, preferably of 1.5 to 9 bar and particularly preferably of 2 to 7 bar, is adjusted. In this case, the contact pressure must be significantly higher than for pyrolytic charcoal. This coal, which results from a pure pyrolysis process, is much denser than the charcoal according to the invention, since volatile components dissolve in the gasification step, and therefore requires less pressure for compression.
Again via conveying devices, the briquetted, still moist charcoal briquettes get into a convection dryer. In the dryer, the moist charcoal briquettes are applied in layers to air-permeable conveyor belts, with a drying temperature of 50 to 140° C., preferably of 65 to 110° C. and particularly preferably of 75 to 105° C., being adjusted. In this case, the level of the drying temperature is scaled with the strength of the fan power.
Again via conveying devices, the dry charcoal briquettes get into a filling plant. In the filling plant, the dry charcoal briquettes are bagged in suitable packages such as, e.g., kraft paper, cardboard, cloth bags or plastic packages, and subsequently they are stored.

Further processing of the charcoal according to the invention is enabled by a process for the production of high-quality activated charcoal and finished activated charcoal. This process provides an ecological option for producing activated carbon, which is produced largely (around 80% of the activated carbon produced worldwide) from fossil coal. The remaining portion of activated carbon is mostly made of coconut shells. Charcoal is processed into activated carbon, if at all, only as a charcoal made from hardwood, the hardwood usually being tropical woods. In addition to the ecological aspect, the charcoal according to the invention has an inner surface area of approx. 200-400 m²/g even before activation, while fossil coal displays no activity whatsoever.

The processing into activated charcoal takes place according to the process illustrated in FIG. 3 and comprises the following steps:
Similar to the process for the production of barbecue charcoal, also here the charcoal according to the invention is first charged in this case into the activation unit, as illustrated in FIG. 3. For this purpose, the charcoal is again emptied from the transport package into the container of the charging system. Alternatively, the charging of the charcoal can also take place directly from an ongoing fluidized bed wood gasification process. In the charging system, a homogenization of the charcoal is performed using the conveying device (e.g., hydraulic cylinders, screw conveyors, conveyor belts).
Again via conveying devices, the homogenized charcoal gets into the activation unit, where the charcoal comes into contact with the activating agent, usually water vapour or carbon dioxide. As illustrated in FIG. 3, the activating agent, like the charcoal, is fed into the activating unit via conveying devices. The temperatures in the activation unit range from 600 to 1100° C., preferably from 700 to 1000° C. and particularly preferably from 800 to 950° C. According to the prior art, the activation temperature of common coal ranges from 1000 to 1100° C. When charcoal according to the invention is used, a lower temperature can be chosen, since the charcoal has already passed through a gasification step. The activation time is 5-180 minutes, preferably 10 to 120 minutes and particularly preferably 15 to 90 minutes.
Furthermore, a specific conversion of the activating agent per 1 g of charcoal of 0.1 to 2 g, preferably of 0.3 to 1.8 g and particularly preferably of 0.4 to 1.6 g, is adjusted during the activation.
Since a gasification process also takes place during the activation, wood gas is likewise produced, as it was already the case in the production of the charcoal according to the invention. This wood gas resulting from the activation unit is utilized energetically in a gas burner or gas motor.
Again via conveying devices, the activated charcoal reaches finishing upon activation, where post-treatment steps are performed on the activated charcoal. In doing so, compacts and agglomerates such as, for example, pellets and granules can be produced from the powdery activated charcoal. Furthermore, the powdery activated charcoal can be impregnated with different mineral substances and substances such as potassium, sodium or calcium salts.
Again via conveying devices, the finished activated charcoal gets to the filling plant, where the activated charcoal is bagged in suitable packages such as, e.g., kraft paper, cardboard, cloth bags or plastic packages and subsequently is stored.

The charcoal according to the invention activated in this way then has an inner surface area of approx. 1000 m²/g, with highly activated laboratory activated charcoal with an inner surface area of up to 2000 m²/g being producible. The inner surface area of the activated charcoal is measured and evaluated using the BET (Brunauer-Emmert-Teller) method.

The second essential parameter for the classification of activated carbon is the pore size, with a distinction being made between micro-, meso- and macropores. The activated charcoal according to the invention can be adjusted specifically to its application in its pore structure. For example, activated charcoals can be produced with a preferably micro- or preferably meso- or preferably macrostructure.

The pore volume is measured using a process of nitrogen adsorption at approx. 71 K, wherein the evaluation of the process can be performed based on the BJH (Barrett, Joyner and Halenda) method.

Further processing of the charcoal according to the invention results from a process for the production of an aggregate for the construction industry.

The processing takes place according to the process illustrated in FIG. 4:
At first, the charcoal according to the invention is charged into the processing unit for industrial charcoal. In doing so, the charcoal is again emptied from the transport package into the container of the charging system.
Again via conveying devices, the charcoal gets to the classifying unit. For being processed as industrial charcoal, the charcoal is divided into different fractions. The division is made into a “coarse”, a “middle” and a “fine fraction”:
   The “coarse fraction” is in a range from approx. 0.4 to 10 mm, preferably from approx. 0.3 to 6 mm and particularly preferably from approx. 0.25 to 4 mm.
   The “middle fraction” is in a range from approx. 100 to 400 μm, preferably from approx. 75 to 300 μm and particularly preferably from approx. 50 to 250
   The “fine fraction” is in a range from approx. 0 to 100 μm, preferably from approx. 0 to 75 μm and particularly preferably from approx. 0 to 50 μm.
After the division, the industrial charcoal gets, as illustrated in FIG. 4, again via conveying devices to the compacting or, respectively, grinding unit, where the industrial charcoal can be processed into a compact or a finer material, depending on the desired product.
In the event of compaction, the compacted industrial charcoal is brought to finishing by means of a conveying device.
In the event of the grinding process, the ground industrial charcoal is taken to classification by means of conveying devices.
Again via conveying devices, the industrial charcoal then reaches finishing, where post-treatment steps are carried out. Compacts and agglomerates such as, for example, briquettes, pellets and granules can be produced from the industrial charcoal, which usually is powdery. Furthermore, the industrial charcoal, which usually is powdery, can be impregnated with various mineral substances and substances such as, for example, potassium, sodium, calcium salts.
Again via conveying devices, the finished industrial charcoal ultimately gets to the filling plant, where the finished industrial charcoal is bagged in suitable packages such as, e.g., kraft paper, cardboard, cloth bags or plastic packages and subsequently is stored.

On the one hand, the use of charcoal as an aggregate in concrete enables lighter concrete components due to the lower density of charcoal, and, on the other hand, the charcoal within the concrete provides an insulation based on the decreasing thermal conductivity, which entails major advantages also in terms of fire protection.

For the use of charcoal as an aggregate and in the metal-working industry, the manufacture and processing thereof is extremely relevant, since charcoal, unlike activated charcoal, should be highly unreactive. Therefore, most of the coal used in this field is fossil. Hence, the charcoal according to the invention offers an ecological alternative to the fossil coal used.

1. A process for the production of charcoal comprising the steps of:
a) feeding biomass, in particular wood chips, into a pyrolysis unit, in which the wood chips are pyrolyzed into a full stream comprising solid, liquid and gaseous material,
b) feeding the full stream and a gasifying agent into an oxidation unit, wherein the full stream is oxidized at least partially and transported pneumatically,
c) feeding the partially oxidized full stream from the oxidation unit into a reduction unit arranged essentially vertically, the material outlet of the oxidation unit being connected to the reduction unit, with the cross-section of the reduction unit increasing as the distance from the material outlet of the oxidation unit increases, the flow rate of the full stream in the reduction unit being adapted to the material of the full stream and to the shape of the flow cross-section of the reduction unit in such a way that a stable fixed bed kept in suspension is formed in the reduction unit,
d) removing the raw charcoal from the reduction unit via an overflow,
e) separating gaseous components in a hot gas filter and collecting the charcoal, and
f) quenching the collected charcoal with water, the charcoal having
a dry matter content of carbon ranging from 68 to 95%,
a dry matter content of ash ranging from 4 to 18%,
a mass percentage of water ranging from 5 to 50%.

2. A process for the production of charcoal according to claim 1, wherein the gaseous components are separated in the hot gas filter at a temperature of 250 to 600° C.

3. A process for the production of charcoal according to claim 1, wherein the hot gas filter comprises porous ceramics.

4. A process for the production of barbecue charcoal briquettes, comprising obtaining charcoal produced according to a process according to claim 1, comprising the following steps of
charging the charcoal into the briquetting line, with a homogenization of the charcoal occurring in the charging system,
mixing the homogenized charcoal with binders and preferably additives in the mixing apparatus,
pre-compressing the charcoal/binder/additive mixture by means of rollers for 1 to 30 minutes, in the pre-compressor,
briquetting the pre-compressed charcoal/binder/additive mixture in the hydraulic roller briquetting plant, the mixture being guided over at least two rollers with shaping cavities at a contact pressure of 1 to 12 bar,
drying the charcoal briquettes at a drying temperature of 50 to 140° C., in a convection dryer,
packaging the dry charcoal briquettes in a filling plant.

5. A process according to claim 4, wherein the binders are selected from the group of recycled vegetable oils, fats, starches, sugar solutions, and cellulose compounds and have a mass percentage of 0.5 to 20%, based on the dry matter of the charcoal briquettes.

6. A process according to claim 4, wherein the additives are selected from the group of calcium compounds, aluminas, gum arabic, and clay minerals and have a mass percentage of 0 to 10%, based on the dry matter of the charcoal briquettes.

7. A process for the production of activated charcoal, comprising obtaining charcoal produced according to a process according to claim 1, comprising the following steps of
charging the charcoal into the activation unit, with a homogenization of the charcoal being performed in the charging system,
activating the homogenized charcoal in the activation unit with an activating agent, at a temperature of 600 to 1100° C., for 5 to 180 minutes, wherein the conversion of the activating agent per 1 g of charcoal is chosen to be 0.1 to 2 g,
finishing the activated charcoal,
packaging the finished activated charcoal in the filling plant.

8. A process for the production of industrial charcoal, in particular an aggregate for concrete or a secondary raw material for the metal-working industry, comprising obtaining charcoal produced according to a process according to claim 1, comprising the following steps of
charging the charcoal into the processing unit,
dividing the charcoal in the classifying unit, wherein, depending on the particle size, it is divided into a coarse, a middle and a fine fraction, the coarse fraction having a particle size of 0.4 to 10 mm, the middle fraction having a particle size of 100 to 400 μm, the fine fraction having a particle size of 0 to 100 μm,
processing the divided charcoal depending on the fraction to form a compact or a finer material in the compacting or, respectively, grinding unit, wherein, after the grinding process, the finer charcoal is again fed into the classifying unit and divided,
finishing the compacted industrial charcoal,
packaging the finished industrial charcoal in the filling plant.

9. A process according to claim 7, wherein during finishing, compacts and agglomerates such as, for example, briquettes, pellets and granules are produced from the charcoal.

10. A process according to claim 7, wherein during finishing, the charcoal is impregnated with preferably mineral substances such as, for example, potassium, sodium and calcium salts.

11. A process according to claim 4, wherein in the filling plant, packages are selected from the group of kraft papers, cardboards, cloth bags and plastic packages.

12. A process for the production of an insulating material, comprising obtaining charcoal produced according to a process according to claim 1 and is mixed with a raw material for insulating materials and is processed into an insulating material.

13. A process for the production of charcoal according to claim 1, the charcoal having an inner surface area of 200 to 400 m²/g.

14. A process for the production of charcoal according to claim 1, the charcoal having:
a dry matter content of carbon ranging from 75 to 93%, or from 80 to 92%,
a dry matter content of ash ranging from 5 to 13%, or from 6 to 10%, and
a mass percentage of water ranging from 10 to 40%, or from 15 to 35%.

15. A process according to claim 4, the method comprising:
pre-compressing the charcoal/binder/additive mixture by means of rollers for 2 to 20 minutes, or for 3 to 10 minutes, in the pre-compressor,
briquetting the pre-compressed charcoal/binder/additive mixture in the hydraulic roller briquetting plant, the mixture being guided over at least two rollers with shaping cavities at a contact pressure of 1.5 to 9 bar, or a contact pressure of 2 to 7 bar,
drying the charcoal briquettes at a drying temperature of 65 to 110° C., or 75 to 105° C., in a convection dryer.

16. A process according to claim 5, wherein the binders have a mass percentage of 1 to 15%, or of 2 to 10%, based on the dry matter of the charcoal briquettes.

17. A process according to claim 6, wherein the additives have a mass percentage of 0.5 to 8%, or 1 to 5%, based on the dry matter of the charcoal briquettes.

18. A process according to claim 7, wherein the activating agent comprises water vapour or carbon dioxide, the temperature is in a range of 700 to 1000° C., or 800 to 950° C., and activation is carried out for 10 to 120 minutes, or 15 to 90 minutes.

19. A process according to claim 7, wherein the conversion of the activating agent per 1 g of charcoal is chosen to be 0.3 to 1.8 g, or 0.4 to 1.6 g.

20. A process according to claim 8, wherein the coarse fraction has a particle size of 0.3 to 6 mm, or 0.25 to 4 mm, the middle fraction has a particle size of 75 to 300 μm, or 50 to 250 μm, and the fine fraction has a particle size of 0 to 75 μm, or 0 to 50 μm.
